(19) United States
(12) Patent Application Publication
(10) Pub. No.: US 2018/0012717 A1
(43) Pub. Date: Jan. 11, 2018

(54) ELECTROMAGNETIC RELAY

(71) Applicant: FUJITSU COMPONENT LIMITED, Tokyo (JP)

(72) Inventors: Hiroaki Kohinata, Tokyo (JP); Yusuke Uchiyama, Tokyo (JP); Koyuru Kobayashi, Tokyo (JP); Satoshi Takano, Tokyo (JP)

(21) Appl. No.: 15/619,660

(22) Filed: Jun. 12, 2017

(30) Foreign Application Priority Data
Jul. 5, 2016 (JP) 2016-133523

(51) Int. Cl. H01H 45/10; H01H 51/01; H01H 50/58; H01H 50/56; H01H 50/32; H01H 50/18; H01H 50/04; H01H 51/28; H01H 45/02

(52) U.S. Cl. CPC H01H 45/10; H01H 51/287; H01H 51/01; H01H 50/58; H01H 45/02; H01H 50/321; H01H 50/18; H01H 50/041; H01H 50/56

(57) ABSTRACT

An electromagnetic relay includes an electromagnet, an armature configured to shift in response to a magnetic force generated by the electromagnet, a movable spring having a movable contact disposed thereon, a fixed spring including a first contact strip and a second contact strip, the first contact strip having a first fixed contact disposed thereon, the second contact strip having a second fixed contact disposed thereon, the first fixed contact and the second fixed contact facing the movable contact, and a linkage member configured to link the armature and the movable spring to shift the movable spring in conjunction with movement of the armature.

### BACKGROUND OF THE INVENTION

### 1. Field of the Invention

The disclosures herein relate to an electromagnetic relay.

### 2. Description of the Related Art

An electromagnetic relay is used as a device for switching between a current conducting state and a current non-conducting state. An electromagnetic relay has a movable contact facing a fixed contact and moving in response to a magnetic field generated by an electromagnet, so that the movable contact makes and breaks a contact with the fixed contact, thereby conducting or stopping electrical current.

A foreign material caught between the movable contact and the fixed contact of the electromagnetic relay may cause electrical conduction failure due to the inability of the movable contact to come in contact with the fixed contact. In consideration of this, there is a type of contact structure of an electromagnetic relay that utilizes a plurality of fixed contacts disposed to face a movable contact, thereby allowing at least one of the plurality of fixed contacts to be in contact with the movable contact despite the presence of a foreign material (see Patent Document 1, for example).

However, the contact structure of an electromagnetic relay disclosed in Patent Document 1 may also suffer electrical conduction failure because a foreign material caught between one of the fixed contacts and the movable contact may cause the remaining fixed contacts to fail to make a contact with the movable contact.

Accordingly, there may be a need to provide an electromagnetic relay that has a lower likelihood of contact failure between contacts caused by foreign material.

### [Patent Document 1] Japanese Patent Application Publication No. 2013-196923

### SUMMARY OF THE INVENTION

It is a general object of the present invention to provide an electromagnetic relay that substantially obviates one or more problems caused by the limitations and disadvantages of the related art.

According to an embodiment, an electromagnetic relay includes an electromagnet, an armature configured to shift in response to a magnetic force generated by the electromagnet, a movable spring having a movable contact disposed thereon, a fixed spring including a first contact strip and a second contact strip, the first contact strip having a first fixed contact disposed thereon, the second contact strip having a second fixed contact disposed thereon, the first fixed contact and the second fixed contact facing the movable contact, and a linkage member configured to link the armature and the movable spring to shift the movable spring in conjunction with movement of the armature.

### BRIEF DESCRIPTION OF THE DRAWINGS

Other objects and further features of the present invention will be apparent from the following detailed description when read in conjunction with the accompanying drawings, in which:

FIG. 1 is a schematic cross-sectional diagram illustrating an example of an electromagnetic relay according to an embodiment;

FIG. 2 is a drawing illustrating an example of a movable-contact spring and a movable contact according to the embodiment;

FIG. 3 is a drawing illustrating an example of a fixed-contact spring and a fixed contact according to the embodiment;

FIGS. 4A and 4B are drawings illustrating an example of the way in which the movable contact is separated from the fixed contacts;

FIGS. 5A and 5B are drawings illustrating an example of the way in which the movable contact is in contact with the fixed contacts; and

FIG. 6 is a drawing illustrating the way in which the movable is in contact with one of the fixed contacts in the presence of a foreign material.

### DESCRIPTION OF THE PREFERRED EMBODIMENTS

In the following, embodiments will be described by referring to the accompanying drawings. In these drawings, the same elements are referred to by the same references, and a description thereof may be omitted.

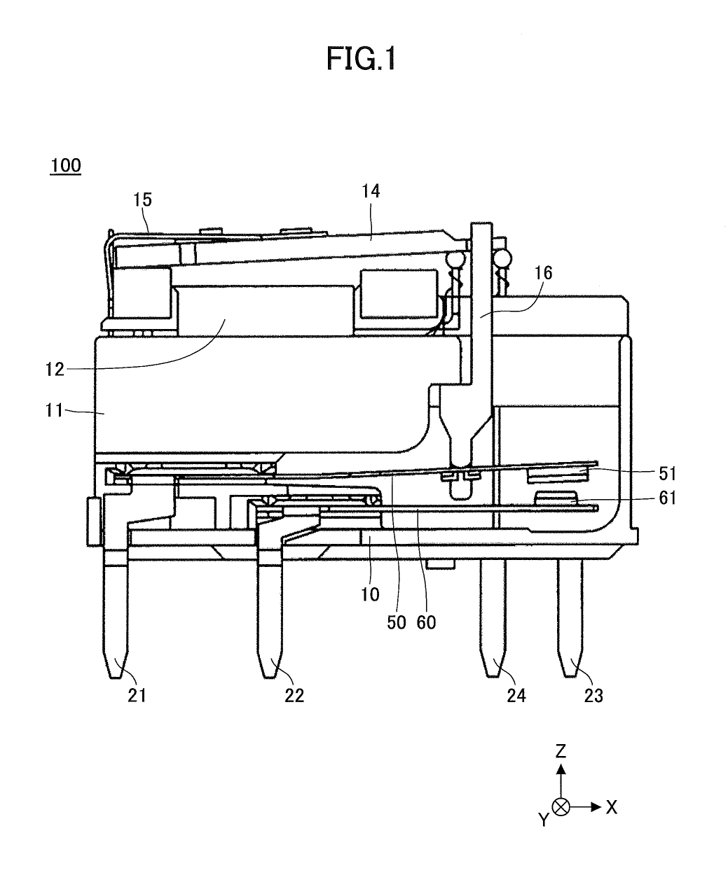

FIG. 1 is a drawing illustrating an example of an electromagnetic relay 100 according to an embodiment. FIG. 1 illustrates a side elevation view of the electromagnetic relay 100 without a cover case. In this and subsequent drawings, the X direction represents the width direction of the electromagnetic relay 100, and the Y direction represents the depth direction, with the Z direction representing the height direction.

As illustrated in FIG. 1, the electromagnetic relay 100 includes a base 10, an electromagnet 12, an armature 14, a card 16, a movable-contact spring 50, a movable contact 51, a fixed-contact spring 60, and a fixed contact 61.

The base 10, which is made of insulating resin material, includes a support part 11 for supporting the electromagnet 12. The electromagnet includes an iron core, a coil, and a case covering the iron core and the coil. The case is mounted on the support part 11. The coil of the electromagnet 12 is coupled to coil terminals 23 and 24. The electromagnet 12 generates a magnetic force when current is conducted to the coil via the coil terminals 23 and 24, and stops generating a magnetic force when the current to the coil is stopped.

The armature 14 is a plate-shaped member made of a magnetic material. The armature 14 has one end thereof secured to a flat spring 15 and the other end thereof connected to the card 16. The flat spring 15 is fixedly attached to the base 10 to urge the armature 14 away from the electromagnet 12.

The armature 14, which moves around one end thereof serving as a pivot point, is pulled toward the electromagnet 12 generating a magnetic force in response to current being conducted to the coil. The armature 14 thus shifts toward the electromagnet 12 (i.e., the right hand end thereof shifts downwardly in FIG. 1), resisting the urge exerted by the flat spring 15. Further, as the electromagnet stops generating a magnetic force upon the stoppage of current to the coil, the armature 14 urged by the flat spring 15 shifts away from the electromagnet 12 (i.e., the right hand end thereof shifts upwardly in FIG. 1).

The card 16, which is made of insulating resin material, serves as a link between the armature 14 and the movable-contact spring 50. The card 16 has one end thereof connected to the armature 14 and the other end thereof connected to the movable-contact spring 50. The card 16 moves upwardly and downwardly in FIG. 1 in conjunction with the movement of the armature 14.

A shift of the armature 14 toward the electromagnet 12 causes the card 16 to shift downward in FIG. 1, thereby pushing the movable-contact spring 50 toward the fixed-contact spring 60. A shift of the armature 14 away from the electromagnet 12 causes the card 16 to shift upward in FIG. 1, thereby moving the movable-contact spring 50 away from the fixed-contact spring 60.

The movable-contact spring 50 is a plate-shaped member made of electrically conductive material. The movable-contact spring 50 has one end thereof secured to the base 10 and coupled to a contact terminal 21. The other end of the movable-contact spring 50 has the movable contact 51 disposed thereon. The movable contact 51 is disposed on the surface of the movable-contact spring 50 on the same side as the fixed-contact spring 60 to face the fixed contact 61.

The fixed-contact spring 60 is a plate-shaped member made of electrically conductive material. The fixed-contact spring 60 has one end thereof secured to the base 10 and coupled to a contact terminal 22. The other end of the fixed-contact spring 60 has the fixed contact 61 disposed thereon. The fixed contact 61 is disposed on the surface of the fixed-contact spring 60 on the same side as the movable-contact spring 50 to face the movable contact 51.

The armature 14 shifting toward the electromagnet 12 pushes the card 16 downwardly in FIG. 1, which pushes the movable-contact spring 50 toward the fixed-contact spring 60, resulting in the movable contact 51 being in contact with the fixed contact 61. As the movable contact 51 and the fixed contact 61 are in contact with each other, the contact terminals 21 and 22 are electrically coupled to each other.

The armature 14 shifting away from the electromagnet 12 pulls the card 16 upwardly in FIG. 1, which pulls the movable-contact spring 50 away from the fixed-contact spring 60, resulting in the movable contact 51 being separated from the fixed contact 61. As the movable contact 51 and the fixed contact 61 are separated from each other, the contact terminals 21 and 22 are electrically isolated from each other.

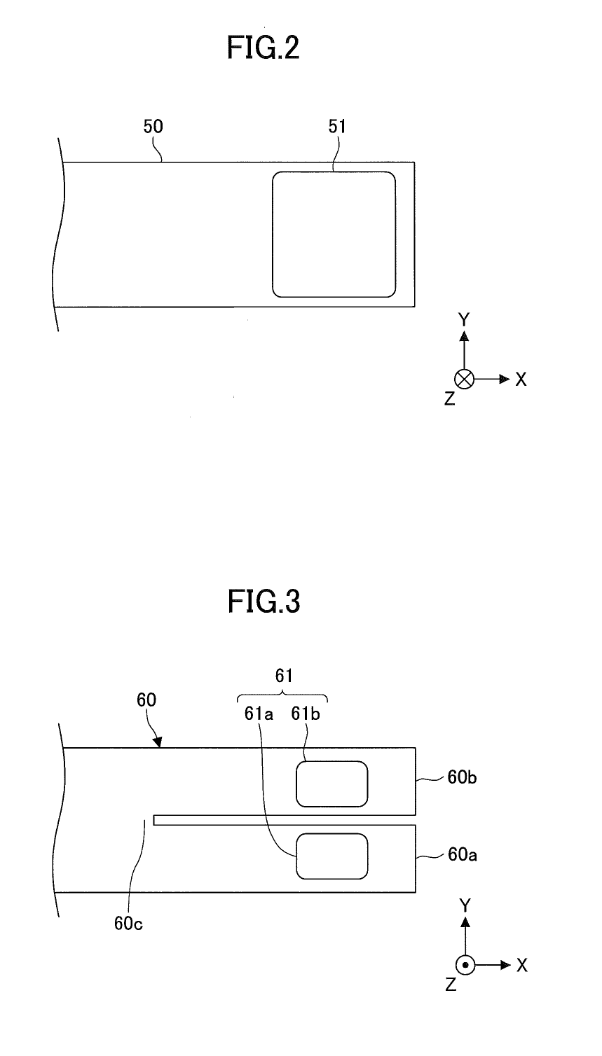

FIG. 2 is a drawing illustrating an example of the movable-contact spring 50 and the movable contact 51 according to the embodiment.

As is illustrated in FIG. 2, the free end of the movable-contact spring 50 (i.e., the right hand end in FIG. 1) has the movable contact 51 disposed thereon.

FIG. 3 is a drawing illustrating an example of the fixed-contact spring 60 and the fixed contact 61 according to the embodiment.

As is illustrated in FIG. 3, the free end of the fixed-contact spring 60 (i.e., the right hand end in FIG. 1) is formed into a first contact strip 60a and a second contact strip 60b, each of which branches from a branch point 60c to extend in the X direction. The first contact strip 60a and the second contact strip 60b are configured to be elastically deformable independently of each other. The first contact strip 60a has a first fixed contact 61a disposed thereon. The second contact strip 60b has a second fixed contact 61b disposed thereon.

The fixed contact 61 is a pair of twin contacts which are the first fixed contact 61a disposed on the first contact strip 60a and the second fixed contact 61b disposed on the second contact strip 60b. Both the first fixed contact 61a and the second fixed contact 61b are configured to come in contact with the movable contact 51. The first fixed contact 61a and the second fixed contact 61b may hereinafter be referred to as the fixed contacts 61a and 61b.

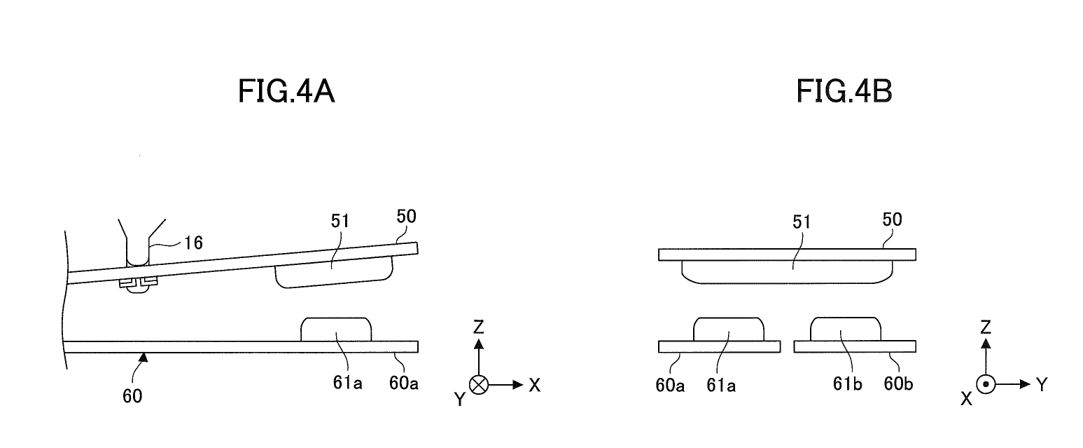

FIGS. 4A and 4B are drawings illustrating an example of the way in which the movable contact 51 is separated from the fixed contacts 61a and 61b. FIG. 4A is a side view, and FIG. 4B is a front view.

In the case of the electromagnet 12 being not excited, the armature 14 urged by the flat spring 15 is separated from the electromagnet 12. In this state, the card 16 is pulled upward in the Z direction by the armature 14, thereby separating the movable-contact spring 50 from the fixed-contact spring 60 as illustrated in FIGS. 4A and 4B, resulting in the movable contact 51 being separated from the fixed contacts 61a and 61b. Separation of the movable contact 51 from the fixed contacts 61a and 61b causes the contact terminals 21 and 22 to be electrically isolated from each other.

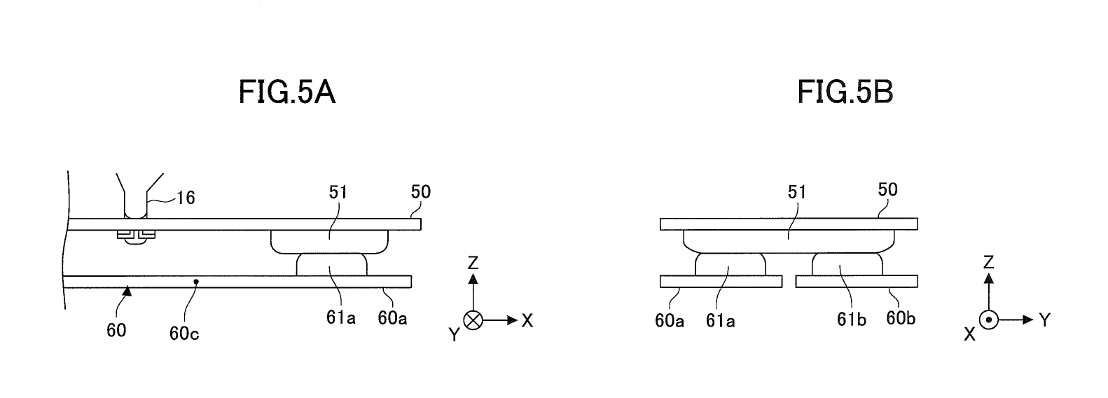

FIGS. 5A and 5B are drawings illustrating an example of the way in which the movable contact 51 is in contact with the fixed contacts 61a and 61b. FIG. 5A is a side view, and FIG. 5B is a front view.

In the case of the electromagnet 12 being excited, the armature 14 is pulled toward the electromagnet 12 against the urge exerted by the flat spring 15. The armature 14 shifting toward the electromagnet 12 pushes the card 16 downwardly in the direction opposite to the Z direction, which pushes the movable-contact spring 50 toward the fixed-contact spring 60 as illustrated in FIGS. 5A and 5B, resulting in the movable contact 51 being in contact with the fixed contacts 61a and 61b. Contact of the movable contact 51 with the fixed contacts 61a and 61b causes the contact terminals 21 and 22 to be electrically coupled to each other.

In the case of no foreign material being present between the movable contact 51 and the fixed contacts 61a and 61b, the movable contact 51 is in contact with both of the fixed contacts 61a and 61b as illustrated in FIG. 5B, so that the contact terminals 21 and 22 are electrically coupled to each other. In this state, the card 16 urges the movable-contact spring 50 at a point situated toward the end of the movable-contact spring 50 that is secured to the base 10. Specifically, the card 16 is in contact with the movable-contact spring 50 at a point situated further toward such an end of the movable-contact spring 50 than the position of the movable contact 51. More specifically, the card 16 is linked to a linkage point of the movable-contact spring 50 wherein the linkage point faces an area of the fixed-contact spring 60 situated between the branch point 60c and the fixed end of the fixed-contact spring 60. Namely, the linkage point is situated between the branch point 60c and the fixed end of the fixed-contact spring 60 in a plan view taken in a direction in which the movable contact 51 moves.

In the electromagnetic relay 100 of the present embodiment, the movable contact 51 is capable of being in contact with the second fixed contact 61b despite the presence of a foreign material between the movable contact 51 and the first fixed contact 61a. Likewise, the movable contact 51 is capable of being in contact with the first fixed contact 61a despite the presence of a foreign material between the movable contact 51 and the second fixed contact 61b. In this manner, the electromagnetic relay 100 uses a single contact as the movable contact 51 and a pair of twin contacts as the fixed contact 61 to avoid contact failure caused by a foreign material, thereby enabling secure electrical conduction between the contact terminals 21 and 22.

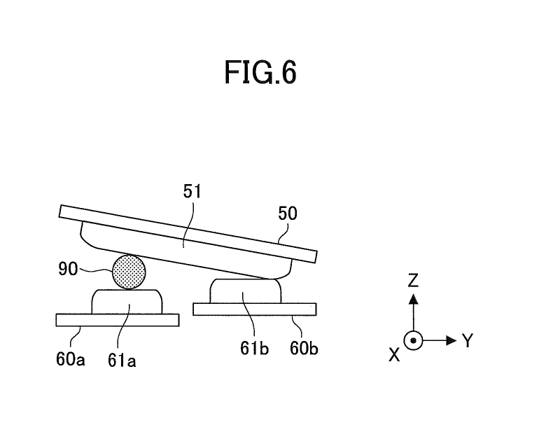

FIG. 6 is a drawing illustrating the way in which the movable contact 51 is in contact with the second fixed contact 61b when a foreign material 90 is present between the movable contact 51 and the first fixed contact 61a.

In the case of the foreign material 90 being present between the movable contact 51 and the first fixed contact 61a, the movable-contact spring 50 pushed by the card 16 exert force on the first contact strip 60a with the foreign material 90 intervening between the movable contact 51 and the first fixed contact 61a. Since the card 16 pushes the movable-contact spring 50 at a point situated toward the end of the movable-contact spring 50 that is secured to the base 10, the movable-contact spring 50 being pushed by the card 16 while the foreign material 90 is present between the movable contact 51 and the first fixed contact 61a causes the movable-contact spring 50 to exhibit torsion as illustrated in FIG. 6. Moreover, the first contact strip 60a is pushed further downward than the second contact strip 60b because of the presence of the foreign material 90 as illustrated in FIG. 6.

The first contact strip 60a and the second contact strip 60b are formed as branches so as to be deformable independently of each other. Because of this, pushing the first fixed contact 61a while the foreign material 90 is present between the movable contact 51 and the first fixed contact 61a causes the first contact strip 60a to shift downward, but the second contact strip 60b does not follow the shift movement of the first contact strip 60a. In the case of the foreign material 90 being present between the movable contact 51 and the first fixed contact 61a, the shift of the first contact strip 60a pushed by the foreign material 90 is greater than the shift of the second contact strip 60b. As a result, the force exerted by the first contact strip 60a on the movable-contact spring 50 is greater than the force exerted by the second contact strip 60b on the movable-contact spring 50.

Moreover, the card 16 in the present embodiment is linked to the movable-contact spring 50 at a point between the movable contact 51 and the fixed end of the movable-contact spring 50 fixed to the base 10. The opposite end of the movable-contact spring 50 on the same side as the movable contact 51 is a free end that is neither fixed nor supported. Further, the card 16 urges the movable-contact spring 50 on the same side as the fixed end of the movable-contact spring 50 fixed to the base 10. Because of this, the movable-contact spring 50, which receives forces of different, respective magnitudes from the first contact strip 60a and the second contact strip 60b due to the presence of the foreign material 90 between the movable contact 51 and the first fixed contact 61a, exhibits a torsion-like deformation as illustrated in FIG. 6. This causes the movable contact 51 and the second fixed contact 61b to come in contact with each other. The movable-contact spring 50 is preferably configured to exhibit elastic torsion between the free end and the point at which the movable-contact spring 50 is pushed by the card 16.

In this manner, the movable contact 51 and the second fixed contact 61b come in contact with each other even when the foreign material 90 is present between the movable contact 51 and the first fixed contact 61a, for example, thereby establishing electrical conduction between the contact terminals 21 and 22. Similarly, the movable contact 51 and the first fixed contact 61a come in contact with each other even when the foreign material 90 is present between the movable contact 51 and the second fixed contact 61b, for example, thereby establishing electrical conduction between the contact terminals 21 and 22.

As described above, the electromagnetic relay 100 of the present embodiment ensures that the movable contact 51 come in contact with one of the fixed contacts 61a and 61b even when a foreign material prevents the movable contact 51 from making contact with the other one of the fixed contacts 61a and 61b, thereby avoiding contact failure. Accordingly, the possibility of contact failure occurring due to a foreign material is reduced.

According to at least one embodiment, an electromagnetic relay is provided that has a lower likelihood of contact failure between contacts caused by foreign material.

Although electromagnetic relay has heretofore been described according to the embodiments, the present invention is not limited to those embodiments. Various changes and modifications may be made without departing from the scope of the invention.

The present application is based on and claims the benefit of priority of Japanese priority application No. 2016-133523 filed on Jul. 5, 2016, with the Japanese Patent Office, the entire contents of which are hereby incorporated by reference.

What is claimed is:

1. An electromagnetic relay, comprising:
an electromagnet;
an armature configured to shift in response to a magnetic force generated by the electromagnet;
a movable spring having a movable contact disposed thereon;
a fixed spring including a first contact strip and a second contact strip, the first contact strip having a first fixed contact disposed thereon, the second contact strip having a second fixed contact disposed thereon, the first fixed contact and the second fixed contact facing the movable contact; and
a linkage member configured to link the armature and the movable spring to shift the movable spring in conjunction with movement of the armature.

2. The electromagnetic relay as claimed in claim 1, wherein the linkage member is connected to a linkage point of the movable spring, the linkage point being situated between the movable contact and a fixed end of the movable spring, and the linkage point of the movable spring is situated between a fixed end of the fixed spring and a branch point of the fixed spring in a plan view taken in a direction in which the movable contact moves, the branch point being a point at which the movable member divides into the first contact strip and the second contact strip.

3. The electromagnetic relay as claimed in claim 1, wherein the first contact strip and the second contact strip are configured to be elastically deformable independently of each other.

4. The electromagnetic relay as claimed in claim 3, wherein the fixed spring is a plate-shaped spring that has the fixed end and a free end, the fixed spring dividing into the first contact strip and the second contact strip toward the free end.

5. The electromagnetic relay as claimed in claim 4, wherein the movable spring is a plate-shaped spring that has a fixed end and a free end, the free end having the movable contact disposed thereon, and the movable spring is configured to exhibit elastic torsion between the fixed end and the free end.

6. The electromagnetic relay as claimed in claim 5, wherein the linkage member is configured to push the movable spring at a point situated between the movable contact and the fixed end of the movable spring.

7. The electromagnetic relay as claimed in claim 6, wherein the movable spring is configured to exhibit elastic torsion between the free end and the point at which the movable spring is pushed by the linkage member.
